(19) United States
(12) Patent Application Publication
(10) Pub. No.: US 2006/0098366 A1
(43) Pub. Date: May 11, 2006

(54) Battery protecting circuit

(76) Inventor: Takeshi Mashiko, Chiba-shi (JP)

Correspondence Address: BRUCE L. ADAMS, ESQ.;31ST FLOOR, 50 BROADWAY, NEW YORK, NY, 10004, US

(21) Appl. No.: 11/155,958

(22) Filed: Jun. 17, 2005

(30) Foreign Application Priority Data
Jul. 5, 2004 (JP) 2004-198543

(51) Int. Cl. H02H 3/20

(52) U.S. Cl. 361/90

(57) ABSTRACT

To provide a battery protecting circuit in which a delay circuit for generating delay times for a plurality of abnormality detecting functions is realized without increasing a circuit scale. A control circuit of a battery protecting circuit is provided with a function of, when an abnormality requiring a short delay time is detected while a delay time is counted, resetting count of the delay time for the detected abnormality.

### BACKGROUND OF THE INVENTION

1. Field of the Invention

The present invention relates to a battery protecting circuit, and more particularly to a delay circuit for generating a delay time for an abnormality detection signal.

2. Description of the Related Art

In general, in a battery protecting circuit, in order to take measures against malfunction caused in an abnormality detecting function due to a noise or the like, a delay time is set until an abnormality detection signal is outputted after detection of an abnormality. In order to suppress cost-up due to increase in circuit scale, generation of a delay time by the delay circuit is realized by dividing a frequency of a signal from an oscillator by a frequency counter.

In particular, in a battery protecting circuit including a plurality of abnormality detecting functions, one delay circuit serves for the abnormality detecting functions to suppress cost-up due to increase in circuit scale (refer to JP 2002-243773 A).

However, in a case of a structure in which one delay circuit is caused to generate delay times for a plurality of abnormality detecting functions, when another abnormality detecting function detects an abnormality while one delay time is counted, it is impossible to simultaneously count two delay times. As a result, a problem occurs in that there is no choice but to stop counting any one of the two delay times or to stop any one of the two abnormality detecting functions.

### SUMMARY OF THE INVENTION

The present invention has been made in order to solve the above-mentioned problem associated with the related art, and it is, therefore, an object of the present invention to provide a battery protecting circuit which is capable of suppressing cost-up due to increase in circuit scale of a delay circuit.

The present invention provides a battery protecting circuit including a control circuit which is provided with a function of, when an abnormality requiring a short delay time is detected while one delay time is counted, resetting the counting of the short delay time for the detected abnormality. Thus, the above-mentioned problem is solved to suppress cost-up of the delay circuit.

The present invention offers an effect in which in the battery protecting circuit including a plurality of abnormality detecting functions, one delay circuit is enabled to count the delay times of a plurality of abnormality detecting functions to suppress cost-up due to increase in circuit scale.

### BRIEF DESCRIPTION OF THE DRAWINGS

In the accompanying drawings:

FIG. 1 is a circuit diagram showing a battery control circuit according to an embodiment of the present invention; and

FIG. 2 is a sequence flow chart explaining an operation of the battery control circuit according to the embodiment of the present invention.

### DETAILED DESCRIPTION OF THE PREFERRED EMBODIMENTS

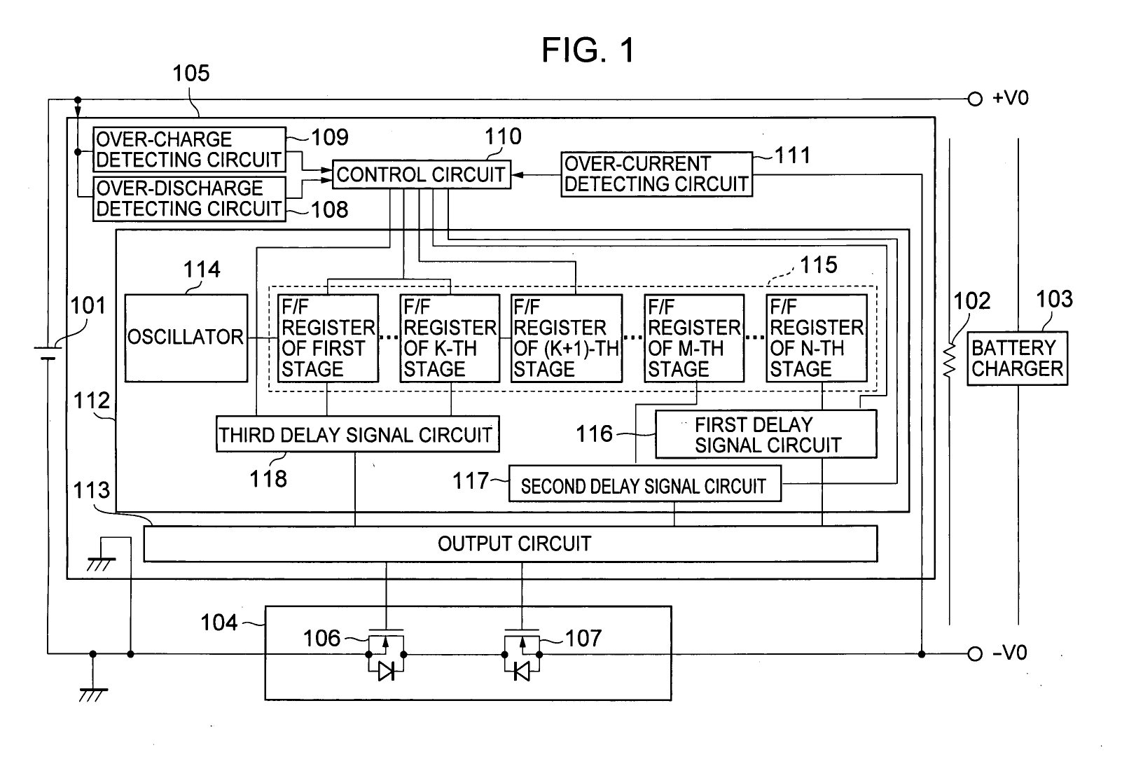

FIG. 1 is a circuit diagram showing a battery control circuit according to an embodiment of the present invention.

A secondary battery 101 is connected to +VO and −VO through a switch circuit 104. Practically, the secondary battery 101 is used with a load 102 and a battery charger 103 being connected between +VO and −VO. A battery control circuit 105 includes: an over-discharge detecting circuit 108; an over-charge detecting circuit 109; an over-current detecting circuit 111; a control circuit 110 for receiving as its inputs detection outputs of the over-discharge detecting circuit 108, the over-charge detecting circuit 109, and the over-current detecting circuit 111; a delay circuit 112 for generating a delay time in accordance with an output of a control circuit 110; and an output circuit 113 for outputting outputs of the delay circuit 112 to the switching circuit 104.

The battery control circuit 105 serves to detect various dangers to the secondary battery 101for protecting the second battery 101 from the various dangers. In the embodiment shown in FIG. 1, the over-charge detecting circuit 109, the over-discharge circuit 108, and the over-current detecting circuit 111 detect an over-charge state in which a battery voltage becomes excessively high due to the charge, an over-discharge state in which the battery voltage becomes excessively low due to the discharge, and an over-current state in which a discharge current of the secondary battery 101 becomes excessively much, respectively, to control the switch circuit 104, thereby protecting the secondary battery 101.

The delay circuit 112 includes: an oscillator 114; a frequency counter 115; a first delay signal circuit 116; a second delay signal circuit 117; and a third delay signal circuit 118. In the delay circuit 112 in this embodiment, an output of an F/F register of an n-th stage is inputted to the first delay signal circuit 116, an output of an F/F register of an m-th stage is inputted to the second delay signal circuit 117, and an output of an F/F register of a k-th stage is inputted to the third delay signal circuit 118. In addition, a control signal for a carry is inputted from the control circuit 110 to an F/F register of a (k+1)-th stage, and a reset signal is inputted from the control circuit 110 to each of F/F registers from a first stage to a k-th stage.

When any one of the over-charge detecting circuit 109, the over-discharge detecting circuit 108, and the over-current detecting circuit 111 detects an abnormality, in the delay circuit 112, the frequency counter 115 frequency-divides a clock signal generated from the oscillator 104 in accordance with an output signal of the control circuit 110 to produce a delay time. The first delay signal circuit 116, the second delay signal circuit 117, and the third delay signal circuit 118 output detection signals to the output circuit 113 after lapses of corresponding delay times, respectively. In addition, the oscillator 114 and the frequency counter 115 are made up in structure into one circuit in order to reduce a circuit scale.

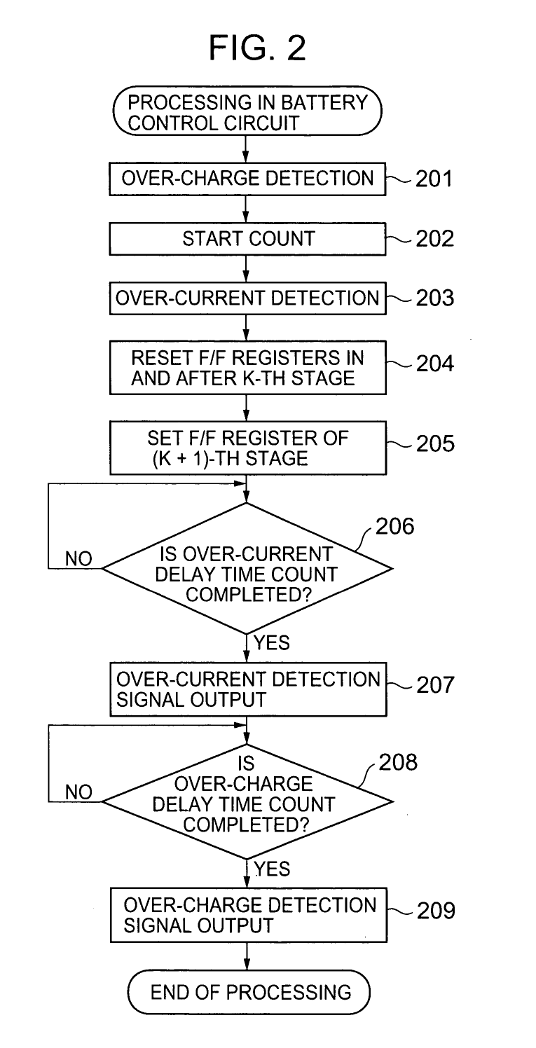

FIG. 2 is a sequence flow chart explaining an operation of the battery control circuit according to this embodiment of the present invention. FIG. 2 shows as an example an operation of the battery control circuit when an over-current is detected while the delay time is counted right after the over-charge was detected, under a condition in which a delay time for an over-charge detection signal is set as being sufficiently longer than that of an over-current detection signal. In the battery control circuit shown in FIG. 1, the delay signal for the over-charge detection signal is outputted from the F/F register of the n-th stage, and the delay signal for the over-current detection signal is outputted from the F/F register of the k-th stage. Hereinafter, the operation of the battery control circuit 105 will be described based on the sequence flow chart shown in FIG. 2.

Firstly, when the over-charge detecting circuit 109 detects the over-charge (201), the control circuit 110 controls the delay circuit 112 so that clocks generated by the oscillator 114 are counted by the frequency counter 115 (202). The delay time for the over-charge detection signal is produced based on the output of the F/F register of the n-th stage of the frequency counter 115. The delay signal for the over-charge detection signal turns OFF a charging switch 107 of the switch circuit 104 through the output circuit 113 to prevent the secondary battery 101 from being excessively charged with electricity. The sequence flow chart of FIG. 2 shows the control when the over-current detecting circuit 111 detects the over-current (203) while the frequency counter 115 counts the delay time for the over-charge detection signal. At this time, the control circuit 110 resets the F/F registers in and before the F/F register of the k-th stage of the frequency counter 115 (204), and sets the F/F register of the (k+1)-th stage (205). As a result, the delay time for the over-current detection signal can be produced by counting the contents of the F/F registers from the first stage to the k-th stage of the frequency counter 115 (206). In addition, the delay time for the over-charge detection signal can also be produced by counting the contents of the F/F registers up to the n-th stage of the frequency counter 115 (208).

In this embodiment, there is executed the processing for carrying a count to the F/F register of the k-th stage when the over-current is detected while the delay time for the over-charge detection signal is counted. However, there may be carried out such control as not to carry a count to the F/F register of the k-th stage.

In addition, the operation of the battery control circuit has been described by giving the relationship between the over-charge and the over-current as an example. However, it is obvious that the above-mentioned technique can also be used in a relationship between the over-discharge and the over-current, a relationship between the over-charge and the over-discharge, or a relationship between other detected abnormalities.

Moreover, the embodiment of the present invention has been described by giving the battery protecting circuit in one cell as an example. However, it is obvious that the above-mentioned technique can be used even for a battery protecting circuit in multiple cells.

What is claimed is:

1. A battery protecting circuit, comprising:
a plurality of detection circuits for detecting abnormalities;
a delay circuit for delaying detection signals of the plurality of detection circuits; and
a switch circuit for controlling charge and discharge of a battery based on an output of the delay circuit,
wherein a frequency counter of the delay circuit has outputs corresponding to a plurality of delay times, and when one of the plurality of detection circuits detects an abnormality requiring a short delay time while a counter portion of the frequency counter counts a long delay time, the delay circuit is instructed to reset a counter portion for counting the short delay time.

2. A battery protecting circuit according to claim 1, wherein when the one of the plurality of detection circuits detects the abnormality requiring the short delay time while the counter portion of the frequency counter counts the long delay time, the delay circuit carries a count of the counter portion for counting the long delay time to a counter portion of a stage next to the counter portion for counting the short delay time.

3. A battery protecting circuit, comprising:
a plurality of detection circuits for detecting abnormalities;
a control circuit for receiving as its inputs detection signals of the plurality of detection circuits;
a delay circuit including a counter for counting delay times in accordance with an output of the control circuit; and
a switch circuit for controlling charge and discharge of a battery based on outputs of the control circuit,
wherein the counter has output terminals corresponding to a plurality of delay times, and a terminal through which a counter portion for counting a short delay time is to be reset.
